(19) United States
(12) Patent Application Publication
(10) Pub. No.: US 2010/0332853 A1
(43) Pub. Date: Dec. 30, 2010

(54) NETWORK TRANSMISSION METHOD, NETWORK TRANSMISSION SYSTEM AND NETWORK TRANSMISSION DEVICE THEREOF

(75) Inventor: Chen Yin LEE, Taipei (TW)

Correspondence Address: Muncy, Geissler, Olds & Lowe, PLLC, 4000 Legato Road, Suite 310, FAIRFAX, VA, 22033, US

(73) Assignee: DynaLab (Singapore) Ltd.

(21) Appl. No.: 12/794,424

(22) Filed: Jun. 4, 2010

(30) Foreign Application Priority Data
Jun. 4, 2009 (TW) 098118493
Jun. 4, 2009 (TW) 098118494

(51) Int. Cl. G06F 12/14; H04J 3/00; H04L 9/00

(52) U.S. Cl. 713/193; 370/464; 380/277; 711/E12.092

(57) ABSTRACT

The present invention discloses a network transmission system, network transmission method, and network transmission device thereof. The network transmission device is connected to an operating center and a user device, and comprises at least one storage device. The operating center is capable of transmitting data to the network transmission device and storing the data in the storage device. Moreover, the operating center is able to control the network transmission device to transmit the data stored in the storage device to the user device

### 1. FIELD OF THE INVENTION

The present invention generally relates to a network transmission device that connects with an operating center and a user device, wherein the network transmission device comprises at least one storage device.

### 2. BACKGROUND OF THE INVENTION:

Conventionally, in virtual computer hardware technology, it is possible for a second user to have access to expensive computer hardware during a break period in hardware operation for a first user because the first user does not utilize the hardware. With rapid developments in computer hardware, it is possible for a third user, and even fourth user, to have access to said computer hardware during a break period in hardware operation by a second user, while the first user does not utilize the hardware. FIG. 1 is a schematic diagram of a virtual host system, wherein a plurality of users may have access to the computer hardware.

In FIG. 1, the virtual host system 10 makes it possible to get the most out of hardware applications. For example, a host 11 can be used as independent virtual host systems 14, 16, and/or 18 when the host 11 is used by users 13, 15, and/or 17 through the processes 123, 125 and 127, respectively, at the same time. More particularly, by the process 123, the user 13 has access to the host 11 as an independent virtual host system 14. Similarly, the user 15 has access to the host 11 as an independent virtual host system 16 by the process 125, and the user 17 has access to the host 11 as an independent virtual host system 18 by the process 127.

As the costs of software grow higher, costs should be shared by more users. FIG. 2 is a schematic diagram of software virtualization. Software virtualization is different from hardware virtualization. Hardware virtualization achieves lower cost by sharing hardware with other users whenever there is a break in hardware operation, while software virtualization achieves lower cost and more valuable service by reducing the opportunity cost of using software.

In FIG. 2, the cost of software is high because there are not enough users to share the cost. As a result, a gap 26 between the supplier and the user appears. More particularly, on the user's side, the user's software storage device 22 (for example, a hard disk drive) coupled with a personal hardware device 21 (for example, a personal computer or a television set) stores software applications 23 and data. As the capacity of the software storage device 22 enlarges, more software applications can be stored. However, most of the software applications 23 are free. The user only pays for software applications 23 when he/she has to. Moreover, the software applications 23 stored in the software storage device 22 occupy only a small amount of hardware capacity. The user pays a one-off defrayal for software, mostly in theaters and video rental shops.

However, on the supplier's side, in the software storage device 24, as the size and cost of software grows a gap 26 between the supplier and the user results from the supplier's attempt to protect intellectual property rights (IPR). The Digital Subscriber Line (DSL) 25 includes an x-Digital Subscriber Line (xDSL) and an Ethernet Passive Optical Network (EPON). Even though the newly developed transmission device exhibits a higher speed, the user may still feel inconvenience as the gap 26 remains.

For example, FIG. 3 shows the relation between an automobile assembly plant and its supply chain. When an automobile assembly plant adopts zero-stock management, the automobile assembly plant has no components in stock. Meanwhile, the components are provided by component suppliers 321, 331, 341, 351, and 361. FIG. 4 shows that the warehouses of the component suppliers 321, 331, 341, 351, and 361 may be built around operating sites 312, 313, 314, 315, and 316 of the zero-stock assembly line so that the component suppliers 321, 331, 341, 351, and 361 are required to be in charge of inventory and risk management.

More particularly, FIG. 4 shows schematic diagrams for the supply-side storage of an operating center and the supply-side software of users. Taking the automobile assembly plant as an operating center 41, for example, the automobile assembly plant 41 adopts zero-stock management and is supplied with components from the warehouses 42 through channels 43 that determine the convenience and efficiency of the supply chain. On the other hand, the software supplier, as an operating center 44, supplies the user with software applications to be stored in a storage medium 45 through channels 46 that determine the convenience and efficiency of the supply chain.

### SUMMARY OF THE INVENTION

It is one object of the present invention to provide a network transmission system, which transmits data to a network transmission device via an x-Digital Subscriber Line (xDSL), an ADSL, a Very High Data Rate DSL (VDSL), and a cable modem or Ethernet Passive Optical Network (EPON), and then stores data in a storage device belonging to the network transmission device.

It is another object of the present invention to provide a network transmission device, which is a cable modem, a set-top-box, or a router, and comprises a storage device for storing data transmitted from an operating center.

To achieve the foregoing objects, the present invention provides a network transmission device connected to an operating center and a user device, wherein the network transmission device comprises at least one storage device and the operating center transmits data to the network transmission device that stores the data in the storage device.

To achieve the foregoing objects, the present invention further provides a network transmission system, comprising: an operating center; a network transmission device comprising a storage device and that is connected to the operating center, wherein the operating center transmits data to the network transmission device that stores the data in the storage device; and a user device connected to the network transmission device to receive the data from the network transmission device.

To achieve the foregoing objects, the present invention further provides a network transmission method, comprising the steps of: transmitting data from an operating center to a network transmission device; and storing the data in a storage device of the network transmission device, wherein the operating center controls the network transmission device to store the data in the storage device.

### BRIEF DESCRIPTION OF THE DRAWINGS

The objects and spirits of the embodiments of the present invention will be readily understood by the accompanying drawings and detailed descriptions, wherein:

FIG. 1 is a schematic diagram of a virtual host system;

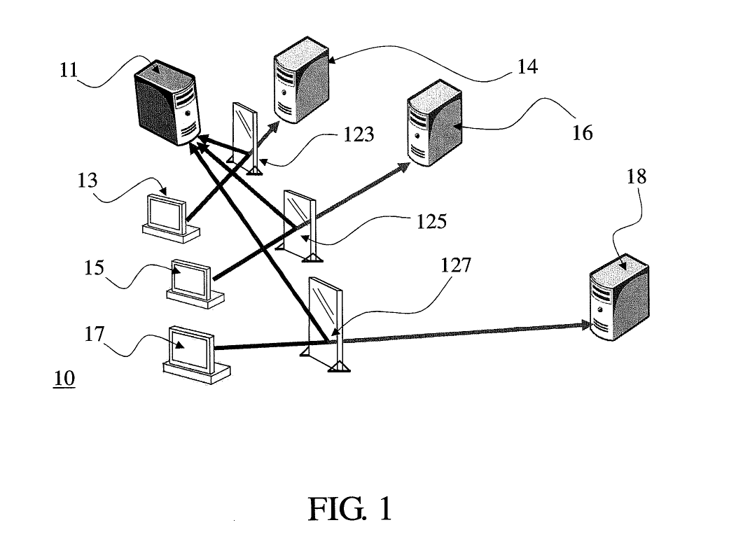

FIG. 2 is a schematic diagram of software virtualization;

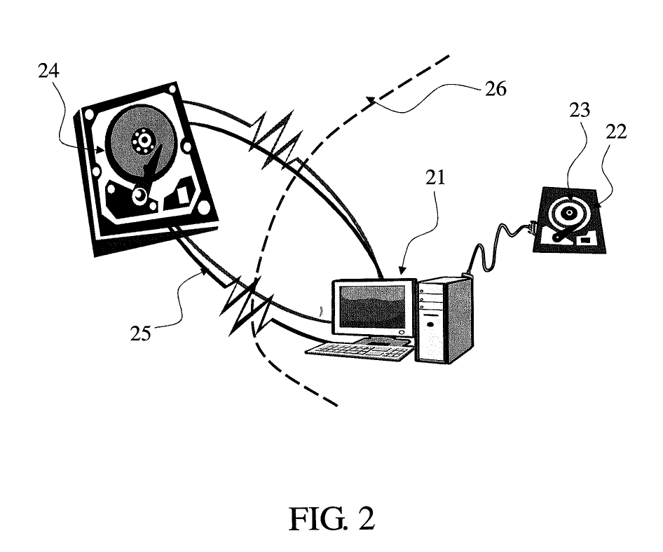

FIG. 3 shows the relationship between an automobile assembly plant and its supply chain;

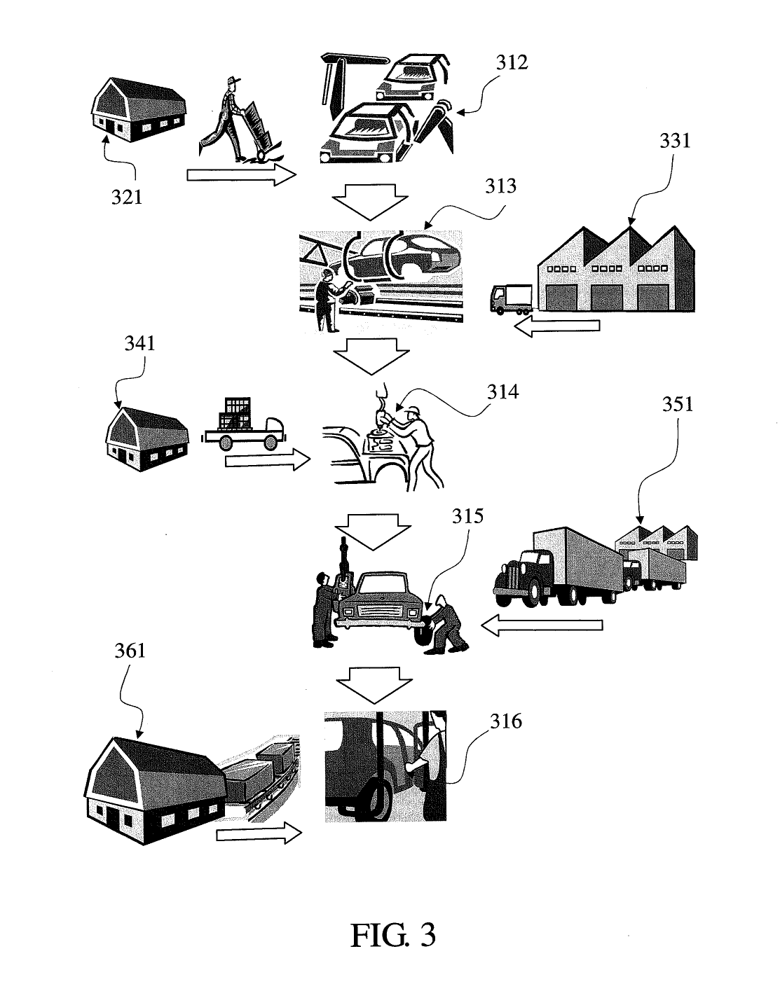

FIG. 4 shows schematic diagrams for the supply-side storage of an operating center and the supply-side software of users;

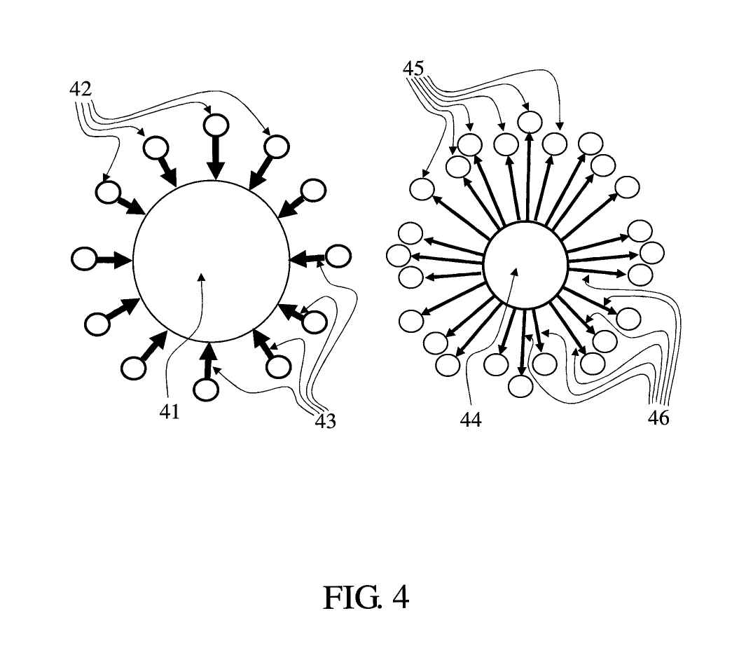

FIG. 5 is a schematic diagram of a network transmission device in a network transmission system according to one embodiment of the present invention;

FIG. 6 is a schematic diagram of a network transmission device in a network transmission system according to another embodiment of the present invention;

FIG. 7 is a schematic diagram of a network transmission device in a network transmission system according to another embodiment of the present invention;

FIG. 8 is a schematic diagram of a network transmission device in a network transmission system according to another embodiment of the present invention; and

FIG. 9 is a schematic diagram of a network transmission device in a network transmission system according to another embodiment of the present invention.

### DETAILED DESCRIPTION OF THE PREFERRED EMBODIMENT

The present invention can be exemplified but not limited by various embodiments as hereafter described.

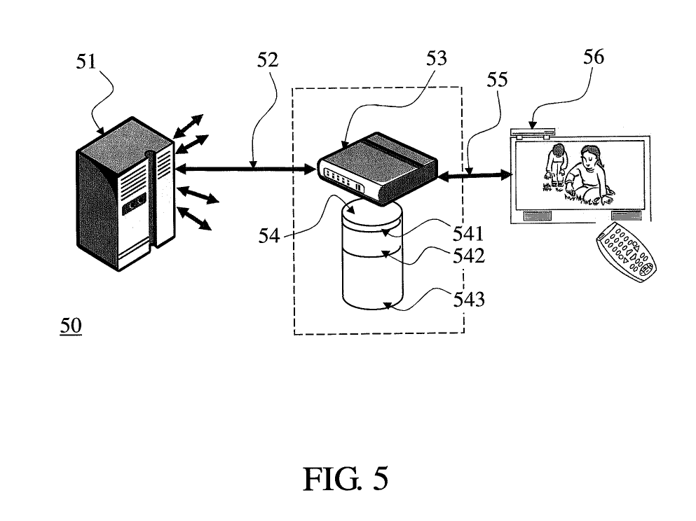

Please refer to FIG. 5, which is a schematic diagram of a network transmission device in a network transmission system according to one embodiment of the present invention. In FIG. 5, the network transmission system 50 comprises an operating center 51, at least one network transmission device 53, and at least one user device 56. The network transmission device 53 comprises a storage device 54.

The network transmission device 53 is connected to an operating center 51 and a user device 56. In one embodiment of the invention, the network transmission device 53 connects to the operating center 51 via a subscriber line 52, and connects to the user device 56 via line 55.

The operating center 51 transmits data to the network transmission device 53 and stores the data in the storage device 54 of the network transmission device 53 when the user device 56 is turned on or off. Moreover, the operating center 51 is capable of controlling the network transmission device 53 and transmitting the data stored in the storage device 54 to the user device 56.

Practically, the user can use the user device 56 to issue a request message to the operating center 51 by way of the network transmission device 53; thereafter, the operating center 51 controls the network transmission device 53 to transmit the data stored in the storage device 54 to the user device 56.

The storage device 54 of the network transmission device 53 comprises, but is not limited to, a hard disk drive and a storage IC with the operation software thereof. The operating center 51, instead of the user device 56, controls the operation of the storage device 54.

The storage device 54 installed to the network transmission device 53 can store a large amount of valuable software content. In one embodiment of the present invention, the network transmission device 53 can be a set-top-box, a router, a modem, an xDSL (x-Digital Subscriber Line), an ADSL, a VDSL (Very High Data Rate DSL), an EPON, or a cable modem. For example, the network transmission device 53 can be a set-top-box, while the user device 56 is a television set. The set-top-box can be installed atop the TV set of a user who still has no access to the software content. The network transmission device 53 and the user device 56 can be owned by the same user.

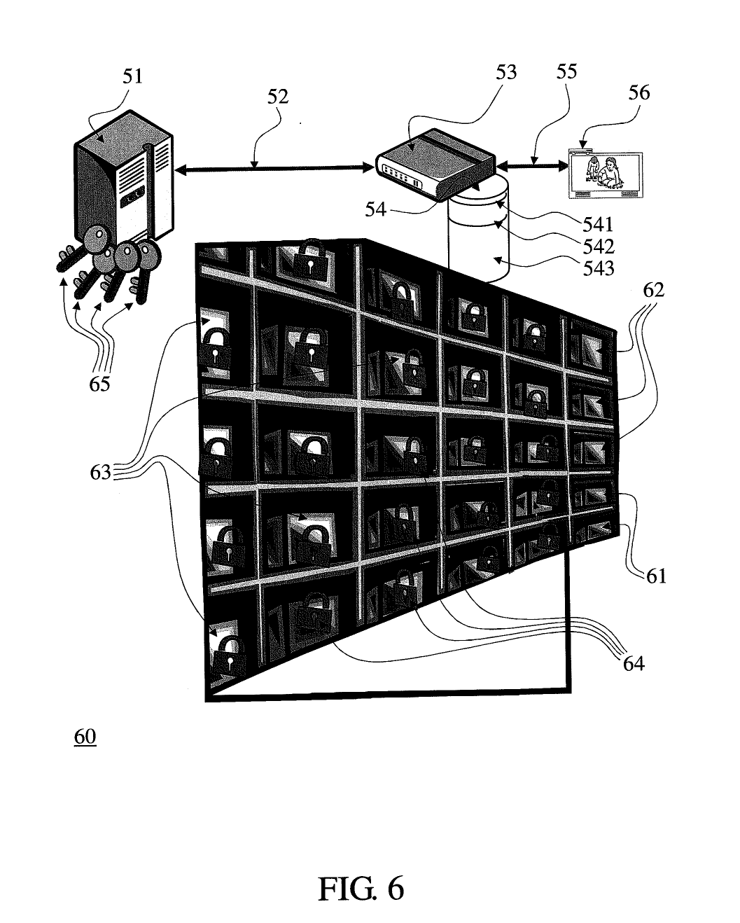

The owner of the network transmission device 53 and user device 56 is not allowed to access the data or software content stored in the storage device 54 without prior permission. Moreover, the network transmission system 50 or the network transmission device 53 can be provided with a mechanism that prevents the data or software content stored in the storage device 54 to be accessed, for example, the encryption keys 64 and the decryption keys 65 in FIG. 6.

The storage device 54 installed to the network transmission device 53 can be a buffer for data transmission from the operating center 51 to the user device 56. The storage device 54 can be a buffer with small capacity or large capacity to store a large amount of data from the operating center 51 when the user device 56 is turned on or off. The data stored in the storage device 54 may comprise, but is not limited to, 100 movies or the transaction logs of global stock markets within a 24-hour period.

The user device 56 cannot legally access data stored in the storage device 54, and the index of the data stored in the storage device 54 is also built in the operating center 51. Moreover, the operating center 51 provides an encryption key 64 and a decryption key 65 corresponding to each data management unit, as shown in FIG. 6. The operating center 51 can decrypt the encryption key 64 of the data management unit via the decryption key 65 that corresponds to the encryption key 64. Accordingly, even if a file stored in the storage device 54 of the network transmission device 53 is illegally accessed, a static protection operation prevents a second file from being illegally accessed.

When the data stored in the storage device 54 of the network transmission device 53 is transmitted to the user device 56, a transmission log thereof is transmitted to the operating center 51, which is a dynamic monitoring operation.

The storage device 54 of the network transmission device 53 comprises an online buffered storage medium 541, an unencrypted offline storage medium 542, and an encrypted offline storage medium 543. The online buffered storage medium 541 can be a buffered storage site for further data after the data already stored on the online buffered storage medium has been transmitted to the user device 56. The operating center 51 stores the encrypted data on the encrypted offline storage medium 543 or encrypts the data stored on the encrypted offline storage medium 543. In one embodiment of the present invention, the operating center 51 first encrypts the data, and then transmits the encrypted data to the network transmission device 53. The operating center 51 further stores the data in the storage device 54 of the network transmission device 53, decrypts the data stored in the storage device 54, and then transmits the decrypted data to the user device 56. Moreover, the operating center 51 stores the unencrypted data on the unencrypted offline storage medium 542. A portion of the data stored on the unencrypted offline storage medium 542 and part or all of the data stored on the encrypted offline storage medium 543 are then stored and processed to expand the capacity of the storage device 54 after receiving instruction from the operating center 51. The processed result and data are then transmitted back to the operating center 51. The user device 56 can control the data stored on the unencrypted offline storage medium 542.

In one embodiment of the present invention, the online buffered storage medium 541 can be a buffered storage site. The operating center 51 transmits the data to the online buffered storage medium 541, and the user device 56 immediately displays or uses the data stored on the online buffered storage medium 541. Otherwise, the data can be played by way of the buffered storage medium 541 when the data is completely processed. Moreover, the operating center 51 previously stored encrypted data that may be used by the user device 56 later on the encrypted offline storage medium 543, and then the user device 56 can display or use the data stored on the encrypted offline storage medium 543. Moreover, the operating center 51 previously stored unencrypted data that may be used by the user device 56 later on the unencrypted offline storage medium 542, and then the user device 56 can display or use the data stored on the unencrypted offline storage medium 542.

Please refer to FIG. 6, which is a schematic diagram of a network transmission device in a network transmission system according to another embodiment of the present invention. In FIG. 6, the network transmission system 60 comprises an operating center 51, at least one network transmission device 53, and at least one user device 56. The network transmission device 53 further comprises a storage device 54.

The network transmission device 53 is connected to an operating center 51 and a user device 56. The operating center 51 transmits data to the network transmission device 53 and stores the data in the storage device 54. Moreover, the operating center 51 is capable of controlling the network transmission device 53 and transmitting the data stored in the storage device 54 to the user device 56.

In one embodiment of the present invention, the online buffered storage medium 541 can be divided into a plurality of storage units 61. The unencrypted offline storage medium 542 can be divided into a plurality of storage units 62. The encrypted offline storage medium 543 can be divided into a plurality of storage units 63. The operating center 51 encrypts data stored in each of the storage units 63 of the encrypted offline storage medium 543 by encryption keys 64, and stores corresponding decryption keys 65 for decrypting data stored in the storage unit 63 of the encrypted offline storage medium 543. Accordingly, the operating center 51 can access the data stored in the storage unit 63 of the encrypted offline storage medium 543. Moreover, the encryption keys 64 of the data storage devices 63 of the encrypted offline storage medium 543 are not identical.

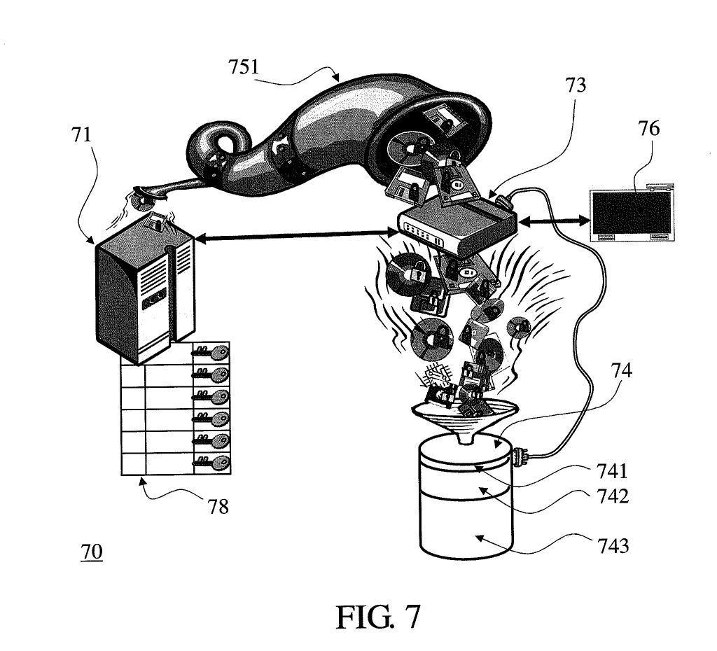

Please refer to FIG. 7, which is a schematic diagram of a network transmission device in a network transmission system according to another embodiment of the present invention. In FIG. 7, the network transmission system 70 comprises an operating center 71, at least one network transmission device 73, and at least one user device 76. The network transmission device 73 further comprises a storage device 74.

The transmission method of the above-mentioned network transmission system 70 comprises the steps of: transmitting data from the operating center 71 to the network transmission device 73, and storing data in the storage device 74 of the network transmission device 73 by the operating center 71. Moreover, the operating center 71 transmits data stored in the storage device 71 to the user device 76 to display or use the data.

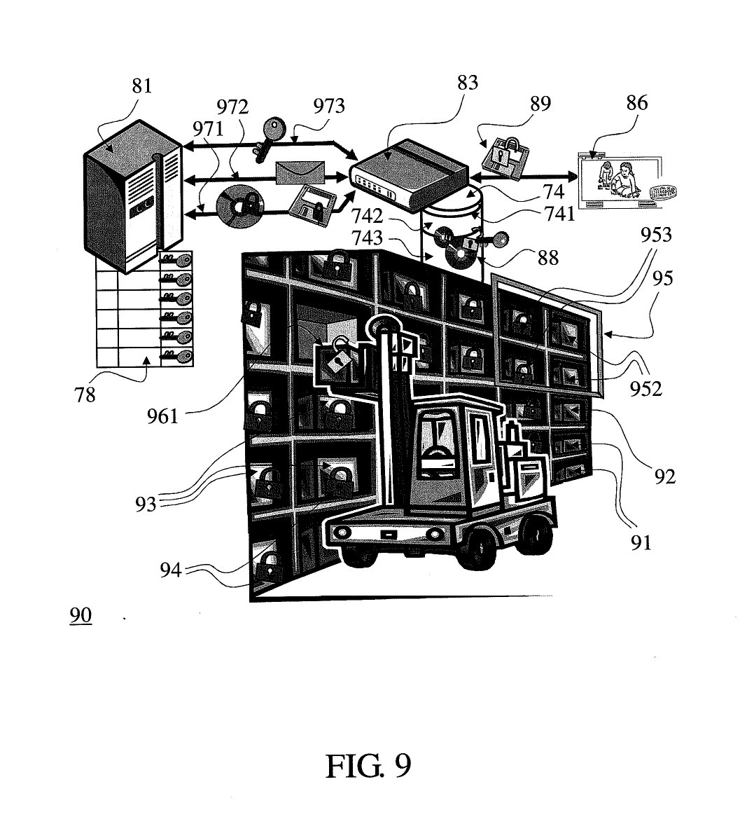

The operating center priorly transmits a large amount of data, such as a broadcast, a movie, a television program, or a software program, to the network transmission device 73, and stores the data in the storage device 74 of the network transmission device 73. In one embodiment of the invention, the operating center 71 can encrypt or decrypt the data. The detailed method will be mentioned in embodiments of FIG. 9.

The operating center 71 exercises the storage of data in the network transmission device 73, and comprises an index 78 to record the decryption key that corresponds to the data and the decryption key that has been transmitted to the network transmission device 73. For example, the network transmission device 73 comprises an index that corresponds to the index 78 of the operating center 71. Furthermore, the index 78 comprises a usage record of decrypted data that has been transmitted to the network transmission device 73.

The operating center 71 exercises the storage of data in the network transmission device 73. Accordingly, the operating center 71 is capable of checking the data stored in the storage device 74, the index 78, and correspondences between the stored data and the index 78. Moreover, the operating center 71 is capable of managing abnormal data and comprises the abilities of, but is not limited to, tracking or checking historical data, and analyzing or comparing abnormal data among different network transmission devices 73.

The network transmission device 73 is able to exercise the transmission of data, as the storage device 74 does not transmit stored data to the user device. In one embodiment of the invention, the network transmission device 73 is a set top box, and the user device is a television. Accordingly, the user can watch a channel or television program that is not stored in the storage device 74 via the set top box and the television.

The operating center 71 is capable of arranging the data stored in the storage device 74 of the network transmission device 73. For example, the operating center 71 exercises the arrangement of the data stored in the storage device 74 of the network transmission device 73 as the user device 76 is turned on or off. The arrangement of the data comprises, but is not limited to, checking the index, checking correspondences between the index and stored data, the deletion of partially stored data, and storing data in the storage unit 74.

The operating center 71 is capable of making and transmitting a questionnaire to the network transmission device 73, or the user gets the questionnaire from the operating center 71 via the user device 76 and/or network transmission device 73. Accordingly, the operating center 71 is able to collect the questionnaire from the user in order to understand the demands of the user. Furthermore, the operating center 71 stores appropriate data in the storage device 74 of the network transmission device 73 according to the user questionnaire. In another embodiment, the questionnaire transmitted by the operating center 71 can also be an advertising message.

In one embodiment of the invention, the operating center 71 transmits a software program 751 to the network transmission device 73 and stores the software program 751 in the storage device 74 of the network transmission device 73 for implementing the software program 751. For example, the software program 751 is capable of establishing the index 78, encrypting or decrypting the data.

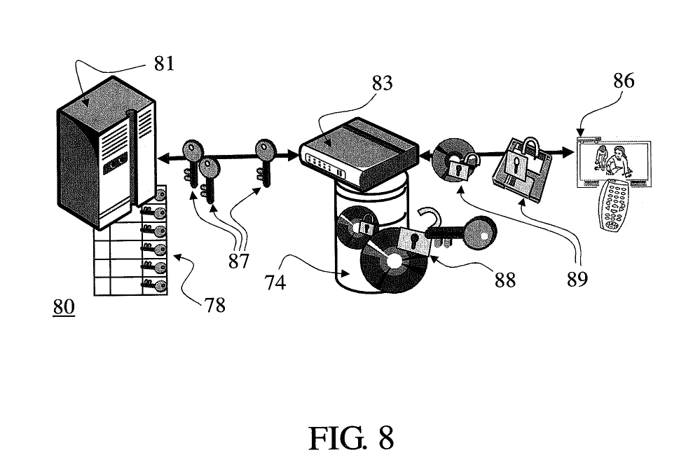

Please refer to FIG. 8, which is a schematic diagram of a network transmission device in a network transmission system according to another embodiment of the present invention. In FIG. 8, the network transmission system 80 comprises an operating center 81, at least one network transmission device 83, and at least one user device 86. The network transmission device 83 further comprises a storage device 74.

Practically, as the user device 86 transmits a request for using the data stored in the storage device 74, the operating center 81 knows the data has been stored in the storage device 72 according to the index 78, finds the decryption key that corresponds to the stored data, and transmits the decryption key to the network transmission device 83. The storage device 74 comprises a software program 87 to manage a plurality of data management units. Furthermore, the operating center 81 is capable of transmitting a decryption key 87 to the network transmission device 83 according to the display or use order of data. The index 78 is able to make a usage log as the user device 86 turns off, at which point the display or use of data is finished.

The operating center 81 transmits the use instruction and decryption key 87 to the network transmission device 83 for decrypting the data 88, and the user device 86 is able to play or use the decrypted data 89.

The user can transmit a request message to the operating center 81 via the network transmission device 83. Thereafter, the operating center 81 acquires information on the data stored in the storage device 74 according to the index of the network transmission device 83, and then transmits decryption keys 87 to the network transmission device 83. The network transmission device 83 decrypts the data stored in the storage device 74 and transmits the decrypted data to the user device 86. The network transmission device 83 can be a modem, a router, a set top box, and so on.

Please refer to FIG. 9, which is a schematic diagram of a network transmission device in a network transmission system according to another embodiment of the present invention. In FIG. 9, the network transmission system 90 comprises an operating center 81, at least one network transmission device 83, and at least one user device 86. The network transmission device 83 further comprises a storage device 74.

The storage device 74 is divided into a plurality of storage units 93, and the operating center 71/81 uses encryption keys 94 to encrypt the data transmitted to and then stored in the storage units 93. In general, the network transmission device 83 cannot decrypt the encrypted data stored in the storage units 93 by itself unless the operating center 81 transmits the decryption key 87 to the network transmission device 83 to decrypt the encrypted data stored in the storage units 74. Then, the network transmission device 83 is able to transmit the decrypted data to the user device 86.

In one embodiment of the invention, the online buffered storage medium 741 is divided into a plurality of storage units 91, and the unencrypted offline storage medium 742 is divided into a plurality of storage units 92. The operating center 81 is capable of controlling the storage units 92 to store data, such as free data, advertising messages, notice messages, questionnaires, and episodes of a television program. Moreover, the user device 86 is able to control part of the unencrypted offline storage medium 742, such as unencrypted private storage mediums 952, to store data. The encrypted offline storage medium 743 is divided into a plurality of storage units 93, and the user device 86 is capable of controlling part of the storage units 93, such as encrypted private storage mediums 953, to store private data that has been encrypted.

After transmitting the decrypted data to the user device 86, the network transmission device 83 will delete the transmitted data. Moreover, the operating center 81 can restore the decrypted data 961. For example, the operating center 91 can encrypt the decrypted data 961 once more, and store the data 961 in the storage device 74 of the network transmission device 83.

As mentioned in the above embodiment, the private storage mediums 95 comprise a plurality of unencrypted private storage mediums 952 and a plurality of encrypted private storage mediums 953. The user device 86, instead of the operating center 81, is capable of controlling the unencrypted private storage mediums 952 and the encrypted private storage mediums 953 to store data. Furthermore, the encrypted private storage mediums 953 are able to store private data, and the operating center 81 assists to decrypt or encrypt this private data.

The data stored in each storage unit 93 of the encrypted offline storage medium 743 has been encrypted. For example, the operating center 81 encrypts the data by encryption keys 84, and stores the encrypted data in the storage unit 93. Moreover, the operating center 81 also stores the decryption keys 971/972/973 in the index 78 thereof.

The foregoing operations can be implemented in the Digital Subscriber Line (DSL) devices of software subscribers so as to provide virtualization software functionality.

Although this invention has been disclosed and illustrated with reference to particular embodiments, the principles involved are susceptible to use in numerous other embodiments that will be apparent to persons skilled in the field. This invention is, therefore, to be limited only as indicated by the scope of the appended claims.

What is claimed is:

1. A network transmission device being connected to an operating center and a user device, wherein the network transmission device comprises at least one storage device and the operating center is capable of transmitting data to the network transmission device and storing the data in the storage device.

2. The network transmission device as recited in claim 1, wherein the operating center controls the network transmission device and transmits the data stored in the storage device to the user device.

3. The network transmission device as recited in claim 1, wherein the storage device comprises an online buffered storage medium, an unencrypted offline storage medium, and an encrypted offline storage medium, and the online buffered storage medium is a buffered storage site for the data.

4. The network transmission device as recited in claim 3, wherein the operating center stores the encrypted data on the encrypted offline storage medium or encrypts the data stored on the encrypted offline storage medium.

5. The network transmission device as recited in claim 3, wherein the operating center stores the unencrypted data on the unencrypted offline storage medium

6. The network transmission device as recited in claim 5, wherein the user device is capable of controlling the data stored on the unencrypted offline storage medium.

7. The network transmission device as recited in claim 1, wherein the operating center comprises an index of the data stored in the storage device.

8. The network transmission device as recited in claim 1, wherein the operating center encrypts the data and transmits the encrypted data to the network transmission device, and the operating center further stores the data in the storage device and decrypts the data stored in the storage device and transmits the decrypted data to the user device.

9. The network transmission device as recited in claim 1, wherein the storage device comprises a plurality of data storage units and provides the data storage units with encryption keys respectively, while the operating center is provided with corresponding decryption keys.

10. The network transmission device as recited in claim 9, wherein the decryption keys of each data storage units are different.

11. The network transmission device as recited in claim 1, wherein the network transmission device transmits a transmission log to the operating center that performs a dynamic monitoring operation when the network transmission device transmits the data stored in the storage device.

12. The network transmission device as recited in claim 1, wherein the user device issues a download request to the operating center host by way of the network transmission device, and then the operating center host controls the network transmission device to transmit the data stored in the storage unit to the user device.

13. The network transmission device as recited in claim 1, wherein the user device is a set-top-box, a router, or a modem.

14. The network transmission device as recited in claim 1, wherein the network transmission device is able to receive the data transmitted from the operating center host and store the data in the storage unit when the user device is turned off.

15. A network transmission system, comprising:
an operating center;
a network transmission device comprising a storage device and being connected to the operating center, wherein the operating center is capable of transmitting data to the network transmission device and storing the data in the storage device; and
a user device being connected to the network transmission device to receive the data from the network transmission device.

16. The network transmission system as recited in claim 15, wherein the operating center controls the network transmission device and transmits the data stored in the storage device to the user device.

17. The network transmission system as recited in claim 15, wherein the storage device comprises an online buffered storage medium, an unencrypted offline storage medium, and an encrypted offline storage medium, and the online buffered storage medium is a buffered storage site for the data.

18. The network transmission system as recited in claim 17, wherein the operating center host stores the encrypted data in the encrypted offline storage medium, encrypts the data stored in the encrypted offline storage medium, or stores the unencrypted data in the unencrypted offline storage medium.

19. The network transmission system as recited in claim 15, wherein the storage unit comprises a plurality of data storage units and provides the data storage units with encryption keys respectively, while the operating center host is provided with corresponding decryption keys.

20. The network transmission system as recited in claim 15, wherein the user device issues a request message to the operating center by way of the network transmission device, and the operating center controls the network transmission device to transmit the data stored in the storage device to the user device.

21. A network transmission method, comprising the steps of:
transmitting data from an operating center to a network transmission device; and
storing the data in a storage device of the network transmission device, wherein the operating center is capable of controlling the network transmission device to store the data in the storage device.

22. The network transmission method as recited in claim 21, wherein the network transmission device comprises an index, and the operating center comprises a corresponding index.

23. The network transmission method as recited in claim 21, further comprising the step of encrypting or decrypting the data, wherein the operating center is capable of encrypting or decrypting the data.

24. The network transmission method as recited in claim 23, further comprising the step of: encrypting the decrypted data once more, and storing the data in the storage device, wherein the operating center is capable of encrypting the decrypted data once more and storing the data in the storage device.

25. The network transmission method as recited in claim 21, further comprising the step of: checking the data stored in the storage device, wherein the operating center is capable of checking the data.

26. The network transmission method as recited in claim 21, further comprising the step of: transmitting the data stored in the storage device of the network transmission device to a user device, wherein the operating center controls the network transmission device to transmit the data stored in the storage device to the user device.

27. The network transmission method as recited in claim 21, further comprising the step of: arranging the data stored in the storage device of the network transmission device, wherein the operating center is capable of arrangement of the data.

28. The network transmission method as recited in claim 27, wherein the arrangement of the data comprises checking the index, checking correspondences between the index and stored data, the deletion of partially stored data, and storing data in the storage unit.

29. The network transmission method as recited in claim 21, further comprising the steps of:
transmitting a request message from the user device to the operating center; and
transmitting the data stored in the storage device from the network transmission device to the user device, wherein the operating center controls the network transmission device to transmit the data stored in the storage device to the user device.

30. The network transmission method as recited in claim 29, further comprising the step of: transmitting a questionnaire from the operating center to the network transmission device.
